(19) United States
(12) Patent Application Publication
(10) Pub. No.: US 2021/0370485 A1
(43) Pub. Date: Dec. 2, 2021

(54) Lightweight Socket Structure

(71) Applicant: KABO Tool Company, Taichung City (TW)

(72) Inventor: Chih-Ching Hsieh, Taichung City (TW)

(73) Assignee: KABO Tool Company

(21) Appl. No.: 17/302,033

(22) Filed: Apr. 22, 2021

(30) Foreign Application Priority Data
May 29, 2020 (TW) 109118214

(51) Int. Cl. B25B 23/00; B25B 13/06

(52) U.S. Cl. CPC B25B 23/0035; B25B 13/06

(57) ABSTRACT

A lightweight socket structure is composed of a fastening end and a driving end, wherein the driving end has a plurality of side connecting surfaces and at least two first holes. The side connecting surfaces are connected around the driving end. Two of the first holes penetrate the driving end symmetrically with respect to the central axis of the lightweight socket structure. The weight of the lightweight socket structure is decreased by the provision of the first holes. The provision of the side connecting surfaces allows the driving end to be connected with force application tools of different types.

### BACKGROUND OF THE INVENTION

### 1. Technical Field

The present invention relates to a socket structure and more particularly to a lightweight socket structure whose weight is reduced compared with its prior art counterparts.

### 2. Description of Related Art

The toolboxes of those who work with locking devices and force application tools usually include sockets of various specifications and sizes so as to cope with the different specifications and uses of those devices and tools.

The conventional sockets are made of metal in order to maintain the torque applied to them and their structural strength. As an indispensable hand tool in the toolbox, however, a group of sockets add substantially to the total weight of the toolbox and hence the load on the toolbox user when the toolbox is carried around.

In view of the above, improvement efforts are called for to reduce the weight, and thereby enhance the carrying convenience, of sockets.

### BRIEF SUMMARY OF THE INVENTION

The present invention provides a lightweight socket structure whose weight has been effectively reduced, and carrying convenience enhanced, by the provision of holes.

One embodiment of the present invention provides a lightweight socket structure that is composed of a fastening end and a driving end. The fastening end is provided at one end of the lightweight socket structure, and the driving end is provided at the opposite end of the lightweight socket structure. The driving end has a plurality of side connecting surfaces and at least two first holes. The side connecting surfaces are connected around the driving end. Two of the first holes penetrate the driving end in a symmetric manner with respect to the central axis of the lightweight socket structure.

The lightweight socket structure according to the foregoing embodiment can be so designed that the side connecting surfaces are connected to form an equilateral polygonal prism or an equiangular polygonal prism.

The lightweight socket structure according to the foregoing embodiment can be so designed that the at least two first holes penetrate at least two of the side connecting surfaces respectively.

The lightweight socket structure according to the foregoing embodiment can be so designed that a connecting portion is provided between each two adjacent side connecting surfaces, and that the at least two first holes penetrate at least two of the connecting portions respectively.

The lightweight socket structure according to the foregoing embodiment can be so designed that the fastening end has and is penetrated by at least one second hole.

The lightweight socket structure according to the foregoing embodiment can be so designed that the number of the at least one second hole is two, and that the two second holes penetrate the fastening end in a symmetric manner with respect to the central axis.

The lightweight socket structure according to the foregoing embodiment can be so designed that the fastening end is configured to connect with a locking device, and that the distance between one end of the at least one second hole and one end of the fastening end is greater than or less than the screw head thickness of the locking device.

The lightweight socket structure according to the foregoing embodiment may further include an annular protruding structure, wherein the annular protruding structure extends outward from and surrounds one end of the driving end and has a greater thickness than the driving end.

The lightweight socket structure according to the foregoing embodiment may further include a plurality of third holes that penetrate the driving end and are different in size from the first holes.

The lightweight socket structure according to the foregoing embodiment may further include a plurality of third holes that penetrate the driving end and are different in shape from the first holes.

### BRIEF DESCRIPTION OF THE SEVERAL VIEWS OF THE DRAWINGS

The above and other objectives, as well as the features, advantages, and following embodiments, of the present invention can be better understood by referring to the accompanying drawings, in which:

FIG. 1 is a perspective view of the lightweight socket structure according to one embodiment of the invention;

FIG. 2 is a sectional view of the lightweight socket structure in FIG. 1;

FIG. 3 is a perspective view of the lightweight socket structure according to another embodiment of the invention;

FIG. 4 is a perspective view of the lightweight socket structure according to still another embodiment of the invention; and

FIG. 5 is a perspective view of the lightweight socket structure according to yet another embodiment of the invention.

### DETAILED DESCRIPTION OF THE INVENTION

A number of embodiments of the present invention are described below with reference to the drawings. In order for the following description to be clear and definite, many practical details are included in the description. It should be understood, however, that those practical details are not intended to limit the invention. That is to say, the practical details are not essential to some embodiments of the invention. In addition, some conventional structures and elements are shown only schematically in the drawings for the sake of simplicity, and repeated elements may be indicated by the same reference numeral.

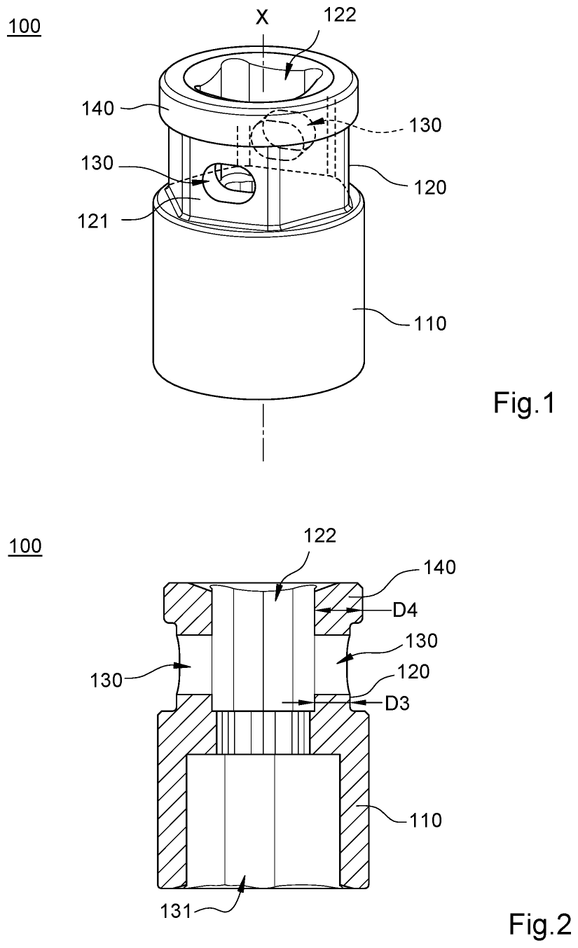

Please refer to FIG. 1 and FIG. 2 respectively for a perspective view of the lightweight socket structure 100 according to one embodiment of the present invention and a sectional view of the lightweight socket structure 100 in FIG. 1. The lightweight socket structure 100 is composed of a fastening end 110 and a driving end 120. The fastening end 110 is provided at one end of the lightweight socket structure 100, and the driving end 120 is provided at the opposite end of the lightweight socket structure 100. The driving end 120 has a plurality of side connecting surfaces 121 and at least two first holes 130. The side connecting surfaces 121 are connected around the driving end 120. Two of the first holes 130 penetrate the driving end 120 symmetrically with respect to the central axis X of the lightweight socket structure 100.

The provision of the first holes 130 effectively reduces the weight of the lightweight socket structure 100 to facilitate carrying and use, and the provision of the side connecting surfaces 121 allows the driving end 120 to connect with force application tools of different types. Moreover, the side connecting surfaces 121 enable a tighter connection between the driving end 120 and a force application tool and thereby enhance the force application effect of the lightweight socket structure 100.

As can be seen in FIG. 2, the fastening end 110 of the lightweight socket structure 100 has a fastening hole 131 for connecting with a locking device (not shown), and the driving end 120 has a driving hole 122 for connecting with a force application tool (not shown). The provision of the fastening hole 131 and the driving hole 122 and the way they are connected with a locking device or a force application tool are well known in the art of hand tool socket structures and therefore will not be detailed herein.

As shown in FIG. 1, the number of the first holes 130 may be just two, and in that case the two first holes 130 penetrate the driving end 120 symmetrically with respect to the central axis X of the lightweight socket structure 100. More specifically, the two first holes 130 respectively penetrate two side connecting surfaces 121 that are symmetric with respect to the central axis X. These two first holes 130, which are symmetric with respect to the central axis X, can be penetrated by a rod (not shown) that serves as a force application tool for driving the lightweight socket structure 100 into rotation and thereby fastening the locking device to be locked or removed. Thus, apart from connecting with a force application tool (e.g., a socket wrench) through the driving hole 122, the lightweight socket structure 100 can connect with a force application tool of a different configuration (e.g., a rod) through the first holes 130. The lightweight socket structure 100, therefore, can work with a greater variety of force application tools, better cope with different operation angles and operation environments, and have wider application than its prior art counterparts. In other embodiments, the number of the first holes 130 can be determined according to user needs and is not limited to that disclosed herein.

With continued reference to FIG. 1, the number of the side connecting surfaces 121 may be six. The provision of the side connecting surfaces 121 renders the driving end 120 of the lightweight socket structure 100 into a polygonal prism so that the driving end 120 can connect with force application tools of different types, such as a ratchet wrench and a box wrench.

More specifically, the side connecting surfaces 121 can be connected to form an equilateral polygonal prism, such as a square prism, an equilateral pentagonal prism, an equilateral hexagonal prism, an equilateral octagonal prism, an equilateral dodecagonal prism, or an equilateral hexadecagonal prism. The side connecting surfaces 121 can also be connected to form an equiangular polygonal prism, such as an equiangular triangular prism, an equiangular quadrilateral prism, an equiangular pentagonal prism, an equiangular hexagonal prism, an equiangular octagonal prism, an equiangular dodecagonal prism, or an equiangular hexadecagonal prism. The number of the side connecting surfaces 121 can be determined as needed and is not limited to those disclosed herein.

Thanks to the provision of the two symmetric first holes 130 and the plurality of side connecting surfaces 121, the lightweight socket structure 100 can work with a greater variety of force application tools, better cope with different operation angles and operation environments, and therefore have wider application than its prior art counterparts. The number and locations of the first holes 130 can be determined according to user needs and are not limited to those disclosed herein.

In addition, the lightweight socket structure 100 may include an annular protruding structure 140 that extends outward from one end of the driving end 120 and surrounds the same end of the driving end 120. As can be seen in FIG. 2, the thickness D4 of the annular protruding structure 140 may be greater than the thickness D3 of the driving end 120. In other words, the annular protruding structure 140 may be thicker than the driving end 120, and the greater thickness will enable the annular protruding structure 140 to enhance the structural strength of the driving end 120 effectively. Moreover, the encircling structural configuration of the annular protruding structure 140 around the driving end 120 contributes to stress distribution and thereby reduces the risk of the lightweight socket structure 100 being damaged or deformed by an exceedingly large applied force, and this helps extend the service life of the lightweight socket structure 100. The provision of the annular protruding structure 140 also makes it possible for a force application tool to engage with the driving end 120 more stably and apply force more effectively than achievable with the prior art.

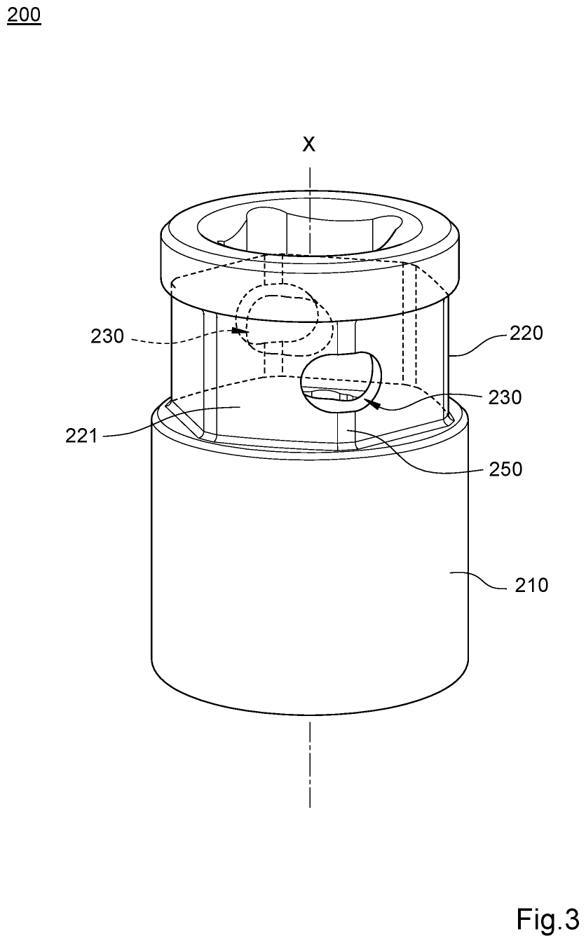

Please refer to FIG. 3 for a perspective view of the lightweight socket structure 200 according to another embodiment of the present invention. The fastening end 210, the driving end 220, and the side connecting surfaces 221 of the lightweight socket structure 200 in FIG. 3 are arranged with respect to one another in a similar way to their counterparts of the lightweight socket structure 100 in FIG. 1, and the same features will not be described repeatedly. The embodiment in FIG. 3 is different in that a connecting portion 250 is provided between each two adjacent side connecting surfaces 221 of the driving end 220, and that each first hole 230 penetrates one of the connecting portions 250.

More specifically, with continued reference to FIG. 3, the number of the side connecting surfaces 221 may be six, which renders the driving end 220 into a hexagonal prism, and in that case the connecting portions 250 form the corners of the hexagonal prism respectively. As shown in FIG. 3, the number of the first holes 230 may be two, and the two first holes 230 may respectively penetrate two connecting portions 250 that are symmetric with respect to the central axis X of the lightweight socket structure 200. In other words, the two first holes 230 may penetrate two opposite corners of the driving end 220 respectively. This configuration enables the lightweight socket structure 200 to cope with different operation angles and operation environments even more effectively.

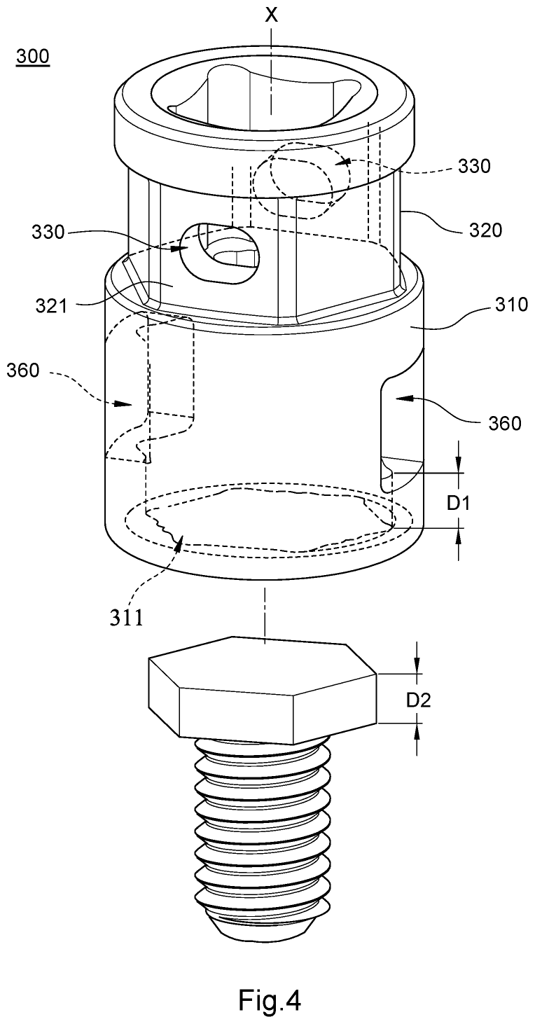

Please refer to FIG. 4 for a perspective view of the lightweight socket structure 300 according to still another embodiment of the present invention. The fastening end 310, the driving end 320, the side connecting surfaces 321, and the first holes 330 of the lightweight socket structure 300 in FIG. 4 are arranged with respect to one another in a similar way to their counterparts of the lightweight socket structure 100 in FIG. 1, and the same features will not be described repeatedly. The embodiment in FIG. 4 is different in that the fastening end 310 of the lightweight socket structure 300 has at least one second hole 360 and is penetrated by the at least one second hole 360. The provision of the at least one second hole 360 further reduces the weight of the lightweight socket structure 300.

More specifically, with continued reference to FIG. 4, the number of the at least one second hole 360 may be two. The two second holes 360 penetrate the fastening 310 symmetrically with respect to the central axis X, and the first holes 330 and the second holes 360 are alternately arranged in the driving end 320 and the fastening end 310. This configuration allows the lightweight socket structure 300 to have more uniform structural strength as a whole, be more resistant to deformation associated with an overly large applied force, and therefore have a longer service life than without the second holes 360. In other embodiments, the number of the at least one second hole 360 can be determined as needed and is not limited to that disclosed herein.

Furthermore, the distance D1 between one end of each second hole 360 and one end of the fastening end 310 may be greater than, equal to, or less than the screw head thickness D2 of a locking device. In the embodiment in FIG. 4, the distance D1 between the aforesaid end of each second hole 360 and the aforesaid end of the fastening end 310 may be less than the screw head thickness D2 of the locking device so that when the fastening hole 311 of the lightweight socket structure 300 is connected with the locking device, the second holes 360 allow the user to directly see how the locking device is locked, to make sure that the locking device is securely connected in the fastening hole 311, and to thereby ensure the force application effect of the lightweight socket structure 300. In other embodiments, the distance D1 between the aforesaid end of each second hole 360 and the aforesaid end of the fastening end 310 may be greater than the screw head thickness D2 of the locking device instead, in order for the fastening end 310 to enclose the screw head of the locking device completely and thereby enhance the force application effect of the lightweight socket structure 300. It should be pointed out that the distance D1 can be determined according to user needs and is not limited to those disclosed herein.

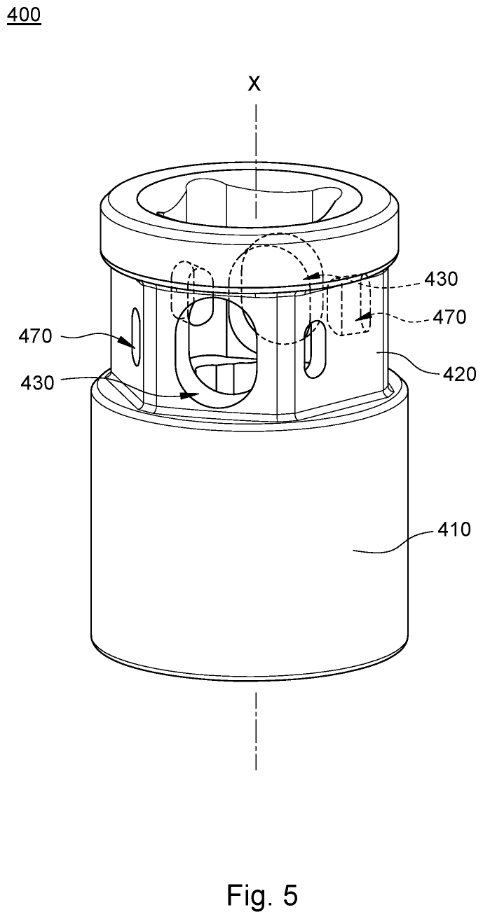

Please refer to FIG. 5 for a perspective view of the lightweight socket structure 400 according to yet another embodiment of the present invention. The fastening end 410, the driving end 420, the first holes 430, and the side connecting surfaces 421 of the lightweight socket structure 400 in FIG. 5 are arranged with respect to one another in a similar way to their counterparts of the lightweight socket structure 100 in FIG. 1, and the same features will not be described repeatedly. The embodiment in FIG. 5 is different in that the lightweight socket structure 400 further includes a plurality of third holes 470 that penetrate the driving end 420, wherein the third holes 470 are different in size and shape from the first holes 430.

More specifically, in the embodiment in FIG. 5 the number of the third holes 470 is four, each third hole 470 is adjacent to one of the first holes 430, and the third holes 470 are arranged in pairs and penetrate the driving end 420 symmetrically with respect to the central axis X. The third holes 470 are configured to be penetrated by force application tools. The provision of the third holes 470, whose size and shape are different from those of the first holes 430, allows the lightweight socket structure 400 to work with a greater variety of force application tools (e.g., force application tools of different sizes and specifications) than the lightweight socket structure 100, so a user can lock and remove locking devices without having to use force application tools of a particular type.

Besides, with continued reference to FIG. 5, the first holes 430 and the third holes 470 are provided in the driving end 420 in a surrounding manner such that the lightweight socket structure 400 can better cope with different operation angles and operation environments than its prior art counterparts to facilitate the locking and removal of locking devices.

In the embodiment in FIG. 5, the third holes 470 may have an elliptical shape. In other embodiments, the number, shape, size, and locations of the third holes 470 may vary according to user needs and are not limited to those disclosed herein.

It should be pointed out that the technical features of the lightweight socket structure embodiments disclosed above can be used in an arbitrary combination to achieve the corresponding effects.

According to the foregoing, the lightweight socket structure of the present invention has the following advantages:

1. The provision of the first holes effectively reduces the weight, and thereby enhances the carrying convenience, of the lightweight socket structure.

2. With two first holes penetrating the driving end in a symmetric manner, the lightweight socket structure can connect with different force application tools.

3. The provision of the side connecting surfaces allows the lightweight socket structure to connect with a greater variety of force application tools, better cope with different operation angles and operation environments, and therefore have greater ease of use and wider application than its prior art counterparts.

4. The provision of the at least one second hole further reduces the weight of the lightweight socket structure. In addition, a user can directly see the state of a locking device through the second hole to make sure that the locking device is securely connected in the tightening hole.

5. The provision of the annular protruding structure helps increase the structural strength, and thereby extend the service life, of the lightweight socket structure.

While the present invention has been disclosed through the foregoing embodiments, it should be understood that the embodiments are not intended to be restrictive of the scope of the invention. A person skilled in the art may alter or modify the disclosed embodiments in many ways without departing from the spirit or scope of the invention. The scope of the patent protection sought by the applicant is defined by the appended claims.

What is claimed is:

1. A lightweight socket structure, composed of a fastening end and a driving end, the fastening end being provided at an end of the lightweight socket structure, the driving end being provided at an opposite end of the lightweight socket structure, wherein the driving end has a plurality of side connecting surfaces and at least two first holes, the side connecting surfaces are connected around the driving end, and two said first holes penetrate the driving end symmetrically with respect to a central axis of the lightweight socket structure.

2. The lightweight socket structure of claim 1, wherein the side connecting surfaces are connected to form an equilateral polygonal prism or an equiangular polygonal prism.

3. The lightweight socket structure of claim 1, wherein the at least two first holes penetrate at least two said side connecting surfaces respectively.

4. The lightweight socket structure of claim 1, wherein each two adjacent said side connecting surfaces are provided therebetween with a connecting portion, and the at least two first holes penetrate at least two said connecting portions respectively.

5. The lightweight socket structure of claim 1, wherein the fastening end has and is penetrated by at least one second hole.

6. The lightweight socket structure of claim 5, wherein the number of the at least one second hole is two, and the two second holes penetrate the fastening end symmetrically with respect to the central axis.

7. The lightweight socket structure of claim 5, wherein the fastening end is configured to connect with a locking device, and a distance between an end of the at least one second hole and an end of the fastening end is greater than or less than a screw head thickness of the locking device.

8. The lightweight socket structure of claim 1, further comprising an annular protruding structure extending outward from and surrounding an end of the driving end, wherein the annular protruding structure has a thickness greater than a thickness of the driving end.

9. The lightweight socket structure of claim 1, further comprising a plurality of third holes penetrating the driving end, wherein the third holes are different in size from the first holes.

10. The lightweight socket structure of claim 1, further comprising a plurality of third holes penetrating the driving end, wherein the third holes are different in shape from the first holes.
